(19) United States
(12) Patent Application Publication
(10) Pub. No.: US 2014/0205248 A1
(43) Pub. Date: Jul. 24, 2014

(54) OPTICAL TRANSMITTER/RECEIVER APPARATUS AND METHOD OF MANUFACTURING SAME

(71) Applicant: NEC CORPORATION, Tokyo (JP)

(72) Inventor: Yasushi Yamada, Tokyo (JP)

(21) Appl. No.: 14/241,226

(22) PCT Filed: Sep. 14, 2012
(86) PCT No.: PCT/JP2012/073643

§ 371 Date: Feb. 26, 2014

(30) Foreign Application Priority Data
Sep. 15, 2011 (JP) 2011-202227

(51) Int. Cl. G02B 6/36

(52) U.S. Cl. CPC G02B 6/36
USPC 385/92; 29/832

(57) ABSTRACT

The purpose of the present invention is to improve the heat dissipation propert(ies) of the circuit board and/or an optical module while securing a sufficient mounting area of a circuit board. An optical transmitter/receiver apparatus includes a case including a base and a cover, a circuit board and an optical module. The circuit board is housed in the case and is fixed to the base. The optical module is housed in the case, is arranged on a side opposite to the base relative to the circuit board, and is fixed to the cover.

### TECHNICAL FIELD

The present invention relates to an optical transmitter/receiver apparatus and a method of manufacturing the same.

### BACKGROUND ART

Optical transmitter/receiver apparatuses such as optical transceivers each include respective components and a case that houses the components. Examples of the components include a circuit board, an optical receiver module and a light-emitting module. In many cases, optical transmitter/receiver apparatuses are mounted on boards housed side by side in a rack cabinet. Thus, the cases of the optical transmitter/receiver apparatuses are subject to limitations in outer shape, and the cases generally have flat plate-like shapes. The outer sizes of the optical transmitter/receiver apparatuses are prescribed by industrial standards called “MSA” (Multi-Source Agreement). In order to provide functions prescribed by the MSA standards, optical transmitter/receiver apparatuses each include a multitude of components.

JP 2005-197569A (hereinafter referred to as Patent Literature 1) discloses an optical transmission module (optical transmitter/receiver apparatus) in which a circuit board, an optical receiver module that receives an optical signal, and an optical transmitter module that transmits an optical signal are directly fixed to a case. Consequently, heat generated from the circuit board, the optical receiver module and the optical transmitter module is radiated from the case.

JP 2006-171398A (hereinafter referred to as Patent Literature 2) describes that a substrate is not fixed to a case and that a predetermined surface of an optical module comes into contact with a predetermined surface of the case and that the optical module is fixed to the case. Heat generated from the optical module is released through the case.

JP 2008-203427A (hereinafter referred to as Patent Literature 3) discloses an optical module (optical transmitter/receiver apparatus) including an optical assembly that houses an optical element to/from which an optical signal is input/output, and a circuit board electrically connected to the optical assembly. The optical assembly is arranged at a predetermined distance from the circuit board, and is electrically connected to the circuit board. The optical assembly is housed in a case. Between the optical assembly and the case, an elastic member having a heat dissipation property is provided. The optical assembly is fixed to the case via the elastic member. More specifically, the case includes an upper case and a lower case resulting from the case being separated into two parts that are upper and lower parts, and the optical assembly is fixed to the upper case via the elastic member. Furthermore, the circuit board is fixed to the upper case by screws being threadably fitted in screw holes in board support pillars. Heat generated from the optical assembly is radiated from the upper case.

In recent years, with a decrease in size, an increase in capacity and enhancement of functions, the densities of components mounted in optical transmitter/receiver apparatuses are becoming higher and higher. In particular, optical transmitter/receiver apparatuses that support 100 Gbps or 40 Gbps digital coherent communications have a large number of components included in the optical transmitter/receiver apparatuses, requiring further higher density mounting. Also, with high density mounting in optical transmitter/receiver apparatuses, enhancement in heat dissipation efficiency of the respective components is demanded. In particular, electric components in digital signal processors such as LSI generate a large amount of heat, and it is desired to suppress the influence of heat from such electric components on the optical module.

It is necessary to house a circuit board and an optical module in a case having a predetermined size. Thus, a part of the circuit board is cut out to secure a space where the optical module is arranged. As described above, an optical transmission module according to each of Patent Literatures 1 and 2, the size of the circuit board is limited because of the cutout in the circuit board (see FIG. 2 in Patent Literature 1 and FIG. 10 in Patent Literature 2). Consequently, the problem of a decrease in mounting area of the circuit board has arisen.

In the optical module described in Patent Literature 3, both the circuit board and the optical assembly are fixed to the upper case. Thus, heat conducted from the optical module to the upper case may be transferred to the circuit board or heat conducted from the circuit board to the upper case may be transferred to the optical module. Thus, the heat dissipation propert(ies) of the circuit board and/or the optical module may deteriorate.

Accordingly, it is desired to provide an optical transmitter/receiver apparatus that can, while securing a sufficient mounting area of a circuit board, enhance the heat dissipation propert(ies) of the circuit board and/or an optical module and a method for manufacturing the same.

### CITATION LIST

### Patent Literature

### Patent Literature 1: JP 2005-197569A

### Patent Literature 2: JP 2006-171398A

### Patent Literature 3: JP 2008-203427A

### SUMMARY OF INVENTION

An optical transmitter/receiver apparatus according to an exemplary embodiment includes a case including a base and a cover, a circuit board and an optical module. The circuit board is housed in the case and is fixed to the base. The optical module is housed in the case, is arranged on a side opposite to the base relative to the circuit board, and is fixed to the cover.

A method of manufacturing an optical transmitter/receiver apparatus according to an exemplary embodiment includes the steps of: fixing a circuit board to a base, placing an optical module on the circuit board, and placing a cover on the base and fastening a screw from outside of the cover to fix the optical module to the cover side.

The above configuration enables heat dissipation properties of a circuit board and an optical module to be enhanced while a sufficient mounting area of the circuit board is secured.

The above object and other objects, features and advantages of the present invention will be clarified in the below description with reference to the accompanying drawings illustrating examples of the present invention.

### BRIEF DESCRIPTION OF DRAWINGS

FIG. 1 is a schematic plan view of an optical transmitter/receiver apparatus.

FIG. 2 is a schematic plan view of the optical transmitter/receiver apparatus with a cover removed.

FIG. 3 is a side view of a configuration of a part around an optical module and a circuit board.

FIG. 4 is an exploded view of the part around the optical module and the circuit board.

FIG. 5 is a diagram illustrating a state in which a circuit board is fixed to a base.

FIG. 6 is a diagram illustrating a state in which an optical module is placed on the circuit board.

FIG. 7 is a schematic cross-sectional diagram illustrating a structure for positioning an optical module relative to a circuit board.

FIG. 8 is a schematic perspective diagram illustrating a structure for positioning the optical module relative to the circuit board.

FIG. 9 is a top view of the base after an excess length of an optical fiber has been processed.

FIG. 10 is a diagram illustrating a state in which the cover has been put on the base.

FIG. 11 is a diagram illustrating another structure for positioning an optical module relative to a circuit board.

### DESCRIPTION OF EMBODIMENTS

An exemplary embodiment of the present invention will be described below with reference to the drawings. The present invention is applicable to optical transmitter/receiver apparatuses including a circuit board and an optical module in general.

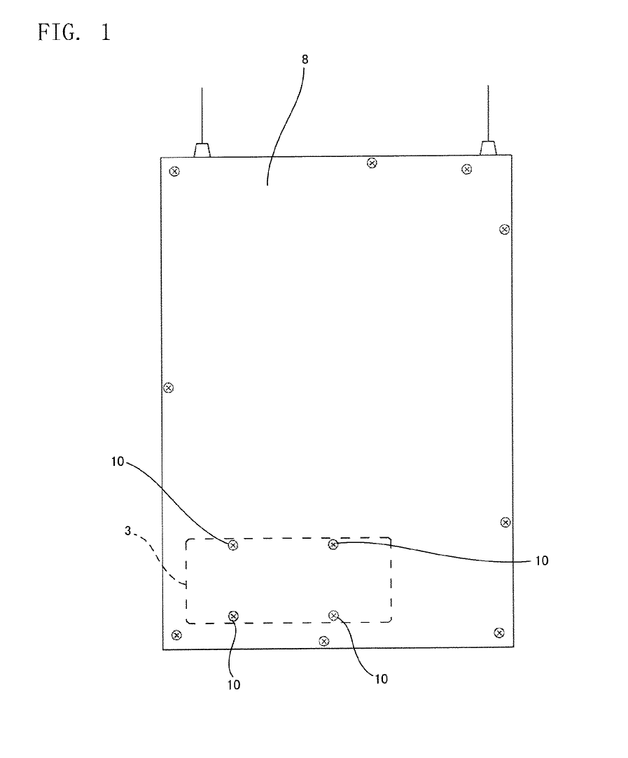

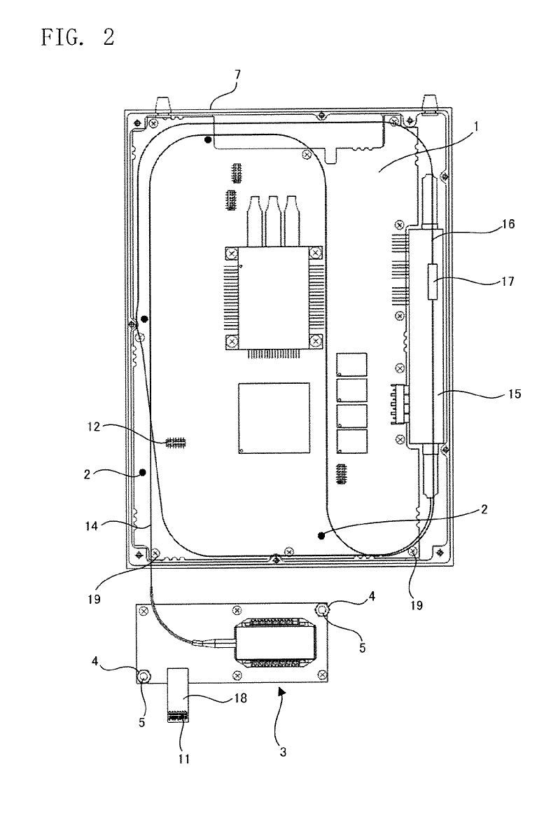

An optical transmitter/receiver apparatus includes a case that houses various components, a circuit board and an optical module. FIG. 1 is a schematic plan view of the optical transmitter/receiver apparatus. FIG. 2 is a schematic plan view of the optical transmitter/receiver apparatus with the cover removed. Circuit board 1 and optical module 3 are housed in a case.

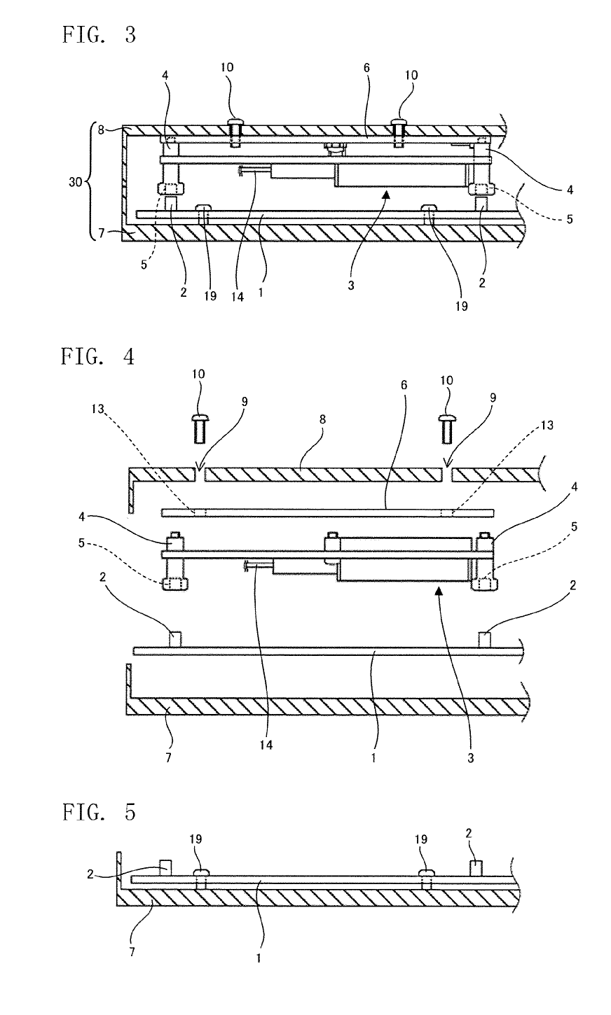

FIG. 3 is a side view illustrating a configuration of a part around circuit board 1 and optical module 3. FIG. 4 is an exploded view illustrating a configuration of the part around circuit board 1 and optical module 3. Case 30 includes base 7 and cover 8. Circuit board 1 is fixed to base 7 via fixing members 19 such as, for example, screws. In circuit board 1, various electric components according to the functions of the optical transmitter/receiver apparatus are mounted.

Optical module 3 includes, for example, a laser module and peripheral circuits. Optical module 3 is arranged at a position closer to cover 8 relative to circuit board 1, the position being at a distance from circuit board 1. Optical module 3 is electrically connected to circuit board 1 via, for example, flexible wiring board 18. More specifically, connector 11 provided at flexible wiring board 18 and connector 12 provided at circuit board 1 are connected to each other.

Optical fiber 14 extends from optical module 3. In the example illustrated in FIG. 2, optical fiber 14 is connected to optical fiber 16 extending from another optical module 15 via splicer 17.

Optical module 3 is fixed to cover 8 via plate 6. Optical module 3 is fixed to plate 6 via fixing members 4 such as, for example, screws. Plate 6 is provided between optical module 3 and cover 8, and is directly fixed to cover 8 via screws 10. More specifically, through holes 9 for fixing plate 6 via screws 10 are provided in cover 8. In plate 6, screw holes 13 are provided at positions corresponding to through holes 9 of cover 8. As described above, in the present exemplary embodiment, optical module 3 is fixed to cover 8 side via plate 6. Alternatively, optical module 3 may be directly fixed to cover 8 via, for examples, screws.

From the perspective of heat dissipation properties, it is preferable that each of base 7 and cover 8 are made of a metal. For heat dissipation property enhancement, a plurality of grooves may be formed at an outer surface of cover 8. Base 7 and cover 8 have a function that radiates heat conducted from circuit board 1 and optical module 3. In the present exemplary embodiment, circuit board 1 is fixed to the base 7 side and optical module 3 is fixed to the cover 8 side, enabling heat from both circuit board 1 and optical module 3 to be efficiently released.

Circuit board 1 and optical module 3 are spaced apart from each other, and an air layer is present between circuit board 1 and optical module 3. The air layer also enables prevention of the influence of heat generated from electric components mounted on circuit board 1 on the optical module. In particular, if the optical module is an optical module having a light emission function, for example, a high-power laser module for long-distance transmission or a wavelength-variable light source module, it is preferable that the optical module be provided at a distance from circuit board 1 because such optical module generates a large amount of heat.

Also, optical module 3 and circuit board 1 arranged in such a manner that optical module 3 and circuit board 1 are vertically spaced apart from each other, eliminate the need to reduce the size of circuit board 1 in order to secure a space for mounting optical module 3. Accordingly, a sufficient mounting area of circuit board 1 can be secured.

For enhancement in heat dissipation efficiency, it is preferable that each of base 7, cover 8 and plate 6 are made of a metal. In order to efficiently transfer heat from optical module 3 to the cover, as illustrated in FIG. 3, it is preferable that plate 6 be in contact with cover 8.

It is preferable that a plurality of pins 2 be provided in circuit board 1. In the present example, two pins 2 are diagonally provided at circuit board 1. Alternatively, three or more pins 2 may be provided at circuit board 1.

In the present exemplary embodiment, hole portion 5 is formed in a head portion of each fixing member 4 that fixes optical module 3 and plate 6 to each other. Each hole portion 5 faces a corresponding one of pins 2 provided at circuit board 1 and has a shape corresponding to the shape of pin 2. Pins 2 are provided coaxially with respective hole portions 5 and have a shape that is insertable into and removable from respective hole portions 5. Pins 2 and hole portions 5 may have any shape such as a circular column or a polygonal column As described later, pins 2 and hole portions 5 are used for placing optical module 3 on circuit board 1 during assembly of the optical transmitter/receiver apparatus.

Next, a method for manufacturing an optical transmitter/receiver apparatus will be described. First, as illustrated in FIG. 5, circuit board 1 is fixed to base 7. Circuit board 1 can be fixed to the base via, for example, screws 19. It is preferable that pins 2 be provided at circuit board 1.

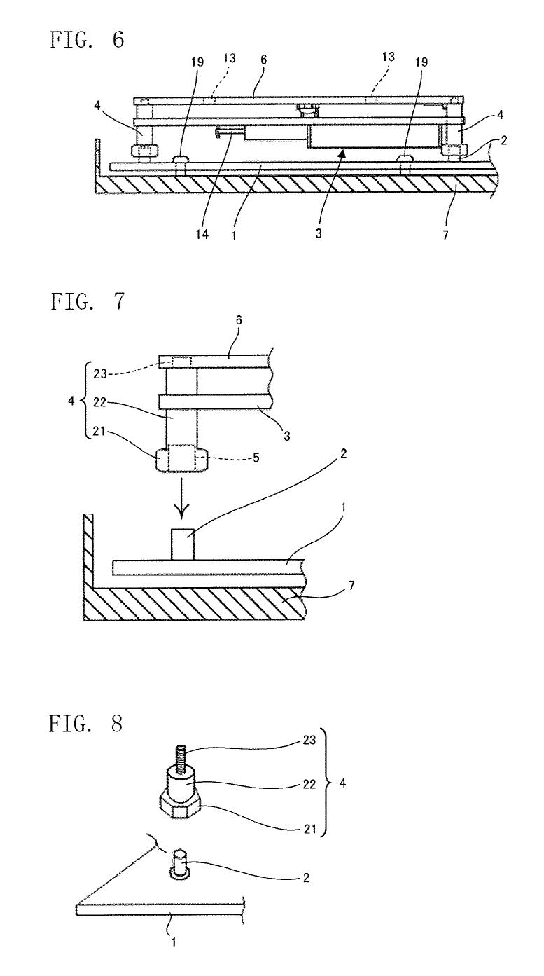

As illustrated in FIG. 6, optical module 3 is placed on circuit board 1. As described above, it is preferable that optical module 3 be fixed to plate 6 via fixing members 4. FIGS. 7 and 8 illustrate a detailed example of a structure for positioning optical module 3 relative to circuit board 1. Fixing members 4 that fix optical module 3 and plate 6 to each other each include head portion 21, column portion 22 and grooved portion 23. Each grooved portion 23 includes a helical groove and is screwed into a corresponding screw hole in plate 6. In each head portion 21, hole portion 5 having a shape corresponding to that of corresponding pin 2 provided in circuit board 1 is formed.

As a result of pins 2 on circuit board 1 being fitted into respective hole portions 5 at head portions 21 of fixing members 4, optical module 3 is temporarily placed at a predetermined position on circuit board 1 with plate 6 directed upward. Consequently, optical module 3 is positioned in a direction parallel to a surface of circuit board 1.

As a result of fixing members 4 that fix optical module 3 and plate 6 to each other being used for placing optical module 3 on circuit board 1, the number of components can be reduced and a sufficient mounting area for optical module 3 can be secured. However, as necessary, members for fixing optical module 3 and plate 6 to each other may be provided separately from members for placing optical module 3 on circuit board 1.

Furthermore, optical module 3 and circuit board 1 are electrically connected. More specifically, connector 11 provided at flexible wiring board 18 is connected to connector 12 provided at circuit board 1, whereby optical module 3 is electrically connected to circuit board 1.

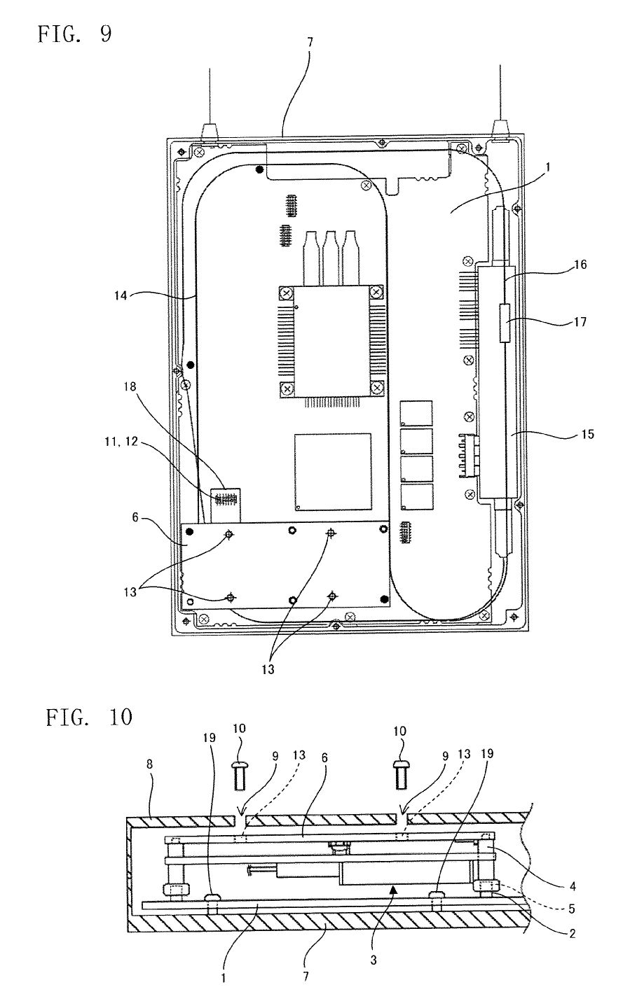

As illustrated in FIG. 9, after placing optical module 3 on circuit board 1, optical fiber 14 extending from optical module 3 is routed on circuit board 1. For example, an excess length of optical fiber 14 extending from optical module 3 is hereby processed. In the example illustrated in FIG. 9, another optical module 15 is provided on base 7, and optical fiber 14 extending from optical module 3 and optical fiber 16 extending from other optical module 15 are interconnected by splicer 17.

If possible, the routing of optical fiber 14 may be performed before placing optical module 3 on circuit board 1.

Next, as illustrated in FIG. 10, cover 8 is put on base 7 and optical module 3 is fixed to cover 8 via screws 10. More specifically, screws 10 are inserted into respective through holes 9 formed in cover 8 and respective screw holes 13 formed in plate 6 from outside of cover 8, and plate 6 is fixed to cover 8 via screws 10. At this time, as a result of screws 10 being turned, plate 6 and optical module 3 fixed to plate 6 are hoisted up from circuit board 1, and move away from circuit board 1. Consequently, optical module 3 is fixed to cover 8 via plate 6. It is preferable that screws 10 be tightened until plate 6 comes into contact with the inner surface of cover 8. Here, it is not necessary that pins 2 be completely removed from hole portions 5.

As described above, optical fiber 14 is routed when both circuit board 1 and optical module 3 are placed on base 7, providing the advantage of being able to easily and correctly route optical fiber 14.

If optical fiber 14 is routed when at least one of circuit board 1 and optical module 3 is fixed to cover 8, optical fiber 14 extends from cover 8 over to base 7. Accordingly, when cover 8 is put on base 7, optical fiber 14 may be displaced or bent. If optical fiber 14 is bent with a predetermined bend radius or more, optical characteristics of optical fiber 14 may deteriorate or optical fiber 14 may be broken. According to the manufacturing method according to the present exemplary embodiment, optical fiber 14 can be routed on circuit board 1 fixed to base 7, enabling such problem to be avoided.

Since optical module 3 and circuit board 1 are electrically connected via a flexible wiring board, it is normally inconceivable that circuit board 1 would be fixed to the base 7 side on the one hand, and that optical module 3 would be fixed to the cover 8 side on the other hand. However, in the manufacturing method according to the present exemplary embodiment, optical module 3 is finally hoisted up a bit to cover 8 side and fixed to cover 8. Consequently, a structure in which circuit board 1 is fixed to the base 7 side and optical module 3 is fixed to the cover 8 side can easily be provided.

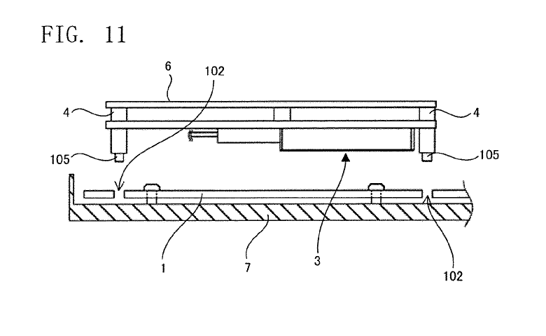

FIG. 11 illustrates another structure for positioning an optical module relative to a circuit board. In FIG. 11, hole portions 102 are provided in circuit board 1 and pins 105 having a shape corresponding to the shape of hole portions 102 are provided at optical module 3. In this case, pins 105 are inserted into respective hole portions 102, whereby optical module 3 can be placed at a predetermined position on circuit board 1. To reduce the number of components, it is preferable that pins 105 be formed at fixing members 4 that fix optical module 3 and plate 6 to each other.

The present application is filed claiming the priority of Japanese Paten Application No. 2011-202227 filed on Sep. 15, 2011, the entire disclosure of which is hereby incorporated by reference.

Although an exemplary embodiment of the present invention has been presented and described in detail above, it should be understood that the present invention is not limited to the above exemplary embodiment and various alterations and modifications are possible without departing from the spirit.

### REFERENCE SIGNS LIST

1 circuit board
2 pin
3 optical module
4 fixing member
5 hole portion
6 plate
7 base
8 cover
9 through hole
10 screw
30 case

1. An optical transmitter/receiver apparatus comprising:
a case including a base and a cover;
a circuit board that is housed in said case and is fixed to said base; and
an optical module that is housed in said case and is arranged on a side opposite to said base relative to said circuit board,
wherein said optical module is fixed to said cover.

2. The optical transmitter/receiver apparatus according to claim 1, comprising:
a hole portion provided in said circuit board or said optical module; and
a pin provided at the remaining of said circuit board or said optical module so as to be coaxial to said hole portion, said pin being insertable into and removable from said hole portion.

3. The optical transmitter/receiver apparatus according to claim 1, comprising a plate provided between said optical module and said cover, said plate being fixed to said optical module,
wherein said plate is fixed to said cover via a screw inserted from outside of said cover.

4. The optical transmitter/receiver apparatus according to claim 3,
wherein said pin is provided at said circuit board; and
wherein said hole portion having a shape corresponding to a shape of said pin is formed in a fixing member that fixes said optical module and said plate to each other.

5. The optical transmitter/receiver apparatus according to claim 3,
wherein said hole portion is provided in said circuit board; and
wherein said pin having a shape corresponding to a shape of said hole portion is formed at a fixing member that fixes said optical module and said plate to each other.

6. The optical transmitter/receiver apparatus according to claim 1, wherein said optical module is electrically connected to said circuit board via a flexible wiring board.

7. A method of manufacturing an optical transmitter/receiver apparatus, the method comprising:
fixing a circuit board to a base;
placing said optical module on said circuit board; and
putting a cover on said base and securing a screw from outside of said cover to fix said optical module to said cover.

8. The method of manufacturing an optical transmitter/receiver apparatus according to claim 7,
wherein when fixing said optical module to said cover, said optical module is hoisted up from said circuit board by rotating said screw.

9. The method of manufacturing an optical transmitter/receiver apparatus according to claim 7, wherein when placing said optical module on said circuit board, a pin provided at said circuit board or said optical module is inserted into a hole portion provided in the remaining of said circuit board or said optical module to position said optical module.

10. The method of manufacturing an optical transmitter/receiver apparatus according to claim 7, further comprising routing an optical fiber extending from said optical module, on said circuit board, between placing said optical module on said circuit board and fixing said optical module to said cover.
